(19) United States
(12) Patent Application Publication
(10) Pub. No.: US 2016/0378333 A1
(43) Pub. Date: Dec. 29, 2016

(54) ELECTRONIC DEVICE THAT DISPLAYS ON-SCREEN KEYBOARD, METHOD FOR CONTROLLING AN ELECTRONIC DEVICE AND RECORDING MEDIUM

(71) Applicant: KYOCERA Document Solutions Inc., Osaka (JP)

(72) Inventor: Takashi ARAKI, Osaka (JP)

(73) Assignee: KYOCERA Document Solutions Inc., Osaka (JP)

(21) Appl. No.: 15/172,783

(22) Filed: Jun. 3, 2016

(30) Foreign Application Priority Data
Jun. 25, 2015 (JP) 2015-127541

(51) Int. Cl. G06F 3/0488; G06F 3/041

(52) U.S. Cl. CPC G06F 3/04886; G06F 3/0416

(57) ABSTRACT

An electronic device includes a touch panel and a control unit. The control unit executes an application program. The control unit executes the application program to be functioned as: a setting acquiring circuit that acquires a software key setting as a setting of an on-screen keyboard displayed on the touch panel; and a software key display circuit that displays the on-screen keyboard on the touch panel corresponding to the software key setting acquired by the setting acquiring circuit. The software key setting includes a timing setting that indicates a timing when the on-screen keyboard is displayed on the touch panel.

### INCORPORATION BY REFERENCE

This application is based upon, and claims the benefit of priority from, corresponding Japanese Patent Application No. 2015-127541 filed in the Japan Patent Office on Jun. 25, 2015, the entire contents of which are incorporated herein by reference.

### BACKGROUND

Unless otherwise indicated herein, the description in this section is not prior art to the claims in this application and is not admitted to be prior art by inclusion in this section.

There has been known an image forming apparatus that displays an on-screen keyboard on an operation panel of the image forming apparatus. The on-screen keyboard is displayed by a specified operation.

### SUMMARY

An electronic device according to one aspect of the disclosure includes a touch panel and a control unit. The control unit executes an application program. The control unit executes the application program to be functioned as: a setting acquiring circuit that acquires a software key setting as a setting of an on-screen keyboard displayed on the touch panel; and a software key display circuit that displays the on-screen keyboard on the touch panel corresponding to the software key setting acquired by the setting acquiring circuit. The software key setting includes a timing setting that indicates a timing when the on-screen keyboard is displayed on the touch panel.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates an MFP according to one embodiment of the disclosure;

FIG. 2 illustrates an exemplary list of set values set on a software key setting according to the one embodiment;

FIG. 3 illustrates an exemplary screen displayed on a touch panel according to the one embodiment in a case of “Floating layout”;

FIG. 4 illustrates an exemplary screen displayed on the touch panel according to the one embodiment in a case of “Right side layout”;

FIG. 5 illustrates an exemplary screen displayed on the touch panel according to the one embodiment in a case of “Horizontal layout”;

FIG. 6 illustrates a performance of the MFP according to the one embodiment in a case where a soft numeric keypad is displayed; and

FIG. 7 illustrates a performance of the MFP according to the one embodiment in a case where the MFP executes a performance corresponding to an operation to the soft numeric keypad displayed on the touch panel.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes one embodiment of the disclosure by referring to the drawings.

First, a description will be given of a configuration of a Multifunction Peripheral (MFP) as an electronic device according to the embodiment.

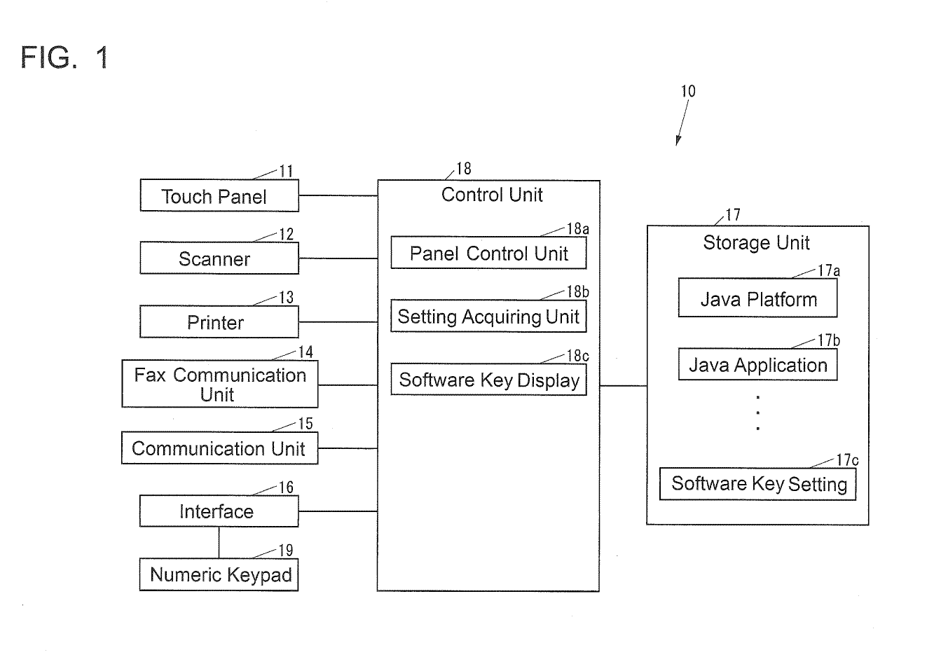

FIG. 1 illustrates an MFP 10 according to the embodiment.

As illustrated in FIG. 1, the MFP 10 includes a touch panel 11, a scanner 12, a printer 13, a fax communication unit 14, a communication unit 15, an interface 16, a storage unit 17, and a control unit 18. The touch panel 11 is an operation device that accepts inputs for various operations and a display device that indicates various kinds of information. The scanner 12 is a reading device that reads image data from an original document. The printer 13 is a print device that executes a print job on a recording medium such as a paper sheet. The fax communication unit 14 is a fax device that performs fax communications with an external facsimile device (not illustrated) via a communication line such as a dial-up line. The communication unit 15 is a communication device that communicates with an external device via a network such as a Local Area Network (LAN) and an Internet. The interface 16 is an interface to which a numeric keypad 19 as a hardware keyboard is removably attachable. The storage unit 17 is a storage device such as a semiconductor memory and a Hard Disk Drive (HDD) to store various kinds of data. The control unit 18 controls the entire MFP 10.

The storage unit 17 can store a Java (registered trademark) Platform 17a. The storage unit 17 is also a non-transitory recording medium and can store a plurality of Java applications 17b as application programs that perform on the Java Platform 17a. The Java Platform 17a and the Java application 17b may be installed on the MFP 10 at production stage of the MFP 10, may be additionally installed on the MFP 10 from a storage medium such as an SD card and a Universal Serial Bus (USB) memory, or may be additionally installed on the MFP 10 from a network location.

The Java Platform 17a is a program that manages a life cycle of the Java application 17b, for example, installation, activation, release of the activation, and uninstallation of the Java application 17b.

The Java application 17b is a program that uses functions of the MFP 10 and cooperates with an MFP other than the MFP 10 to extend the functions of the MFP 10. The Java application 17b uses the following functions of the MFP 10: scan as a function to read image data from the original document by the scanner 12, copying as a function to execute the print job on the recording medium by the printer 13 based on the image data read from the original document by the scanner 12, sending as a function to transmit data such as image data via the fax communication unit 14 or the communication unit 15, and similar function.

The storage unit 17 can store a software key setting 17c as a setting of a soft numeric keypad that is an on-screen keyboard displayed on the touch panel 11.

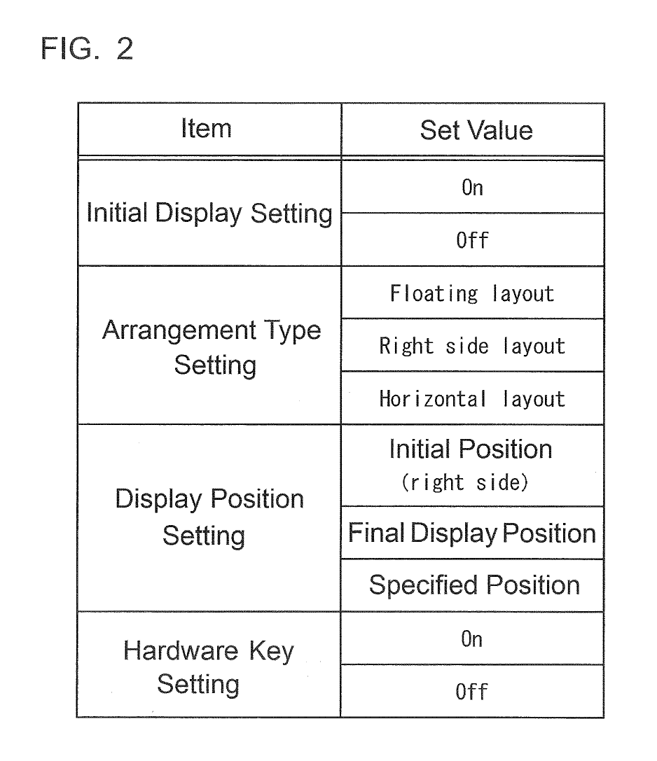

FIG. 2 illustrates an exemplary list of set values set on the software key setting 17c.

As illustrated in FIG. 2, the software key setting 17c includes items of an “initial display setting,” an “arrangement type setting,” a “display position setting,” and a “hardware key setting. The “initial display setting” indicates whether or not the soft numeric keypad is displayed at the point when the screen of the Java application 17b is started to be displayed on the touch panel 11. The “arrangement type setting” indicates a type of an arrangement of the soft numeric keypad on the touch panel 11. The “display position setting” indicates an initial display position of the soft numeric keypad on the touch panel 11 in a state where the type of the arrangement of the soft numeric keypad on the touch panel 11 is a “Floating layout” (described below). The “hardware key setting” indicates a state of the installation of the numeric keypad 19 to the interface 16.

The “initial display setting” is configured to be set any of set values of “On” and “Off.” The “On” indicates to display the soft numeric keypad at the point when the screen of the Java application 17b is started to be displayed on the touch panel 11. The “Off” indicates not to display the soft numeric keypad at the point when the screen of the Java application 17b is started to be displayed on the touch panel 11. The “initial display setting” is configured to be set the set values corresponding to an instruction via, for example, the touch panel 11 or the communication unit 15. The “initial display setting” indicates the timing when the soft numeric keypad is displayed on the touch panel 11 and configures the timing setting of the disclosure.

The “arrangement type setting” is configured to be set any of the set values of the “Floating layout,” a “Right side layout,” and a “Horizontal layout.” The “Floating layout” indicates that the soft numeric keypad can be located on any position on the touch panel 11. The “Right side layout” indicates that the soft numeric keypad is located on the right edge side of the touch panel 11. The “Horizontal layout” indicates that the soft numeric keypad is located on the lower end side of the touch panel 11 in a state of horizontally long. The “arrangement type setting” is configured to be set the set values corresponding to an instruction via, for example, the touch panel 11 or the communication unit 15.

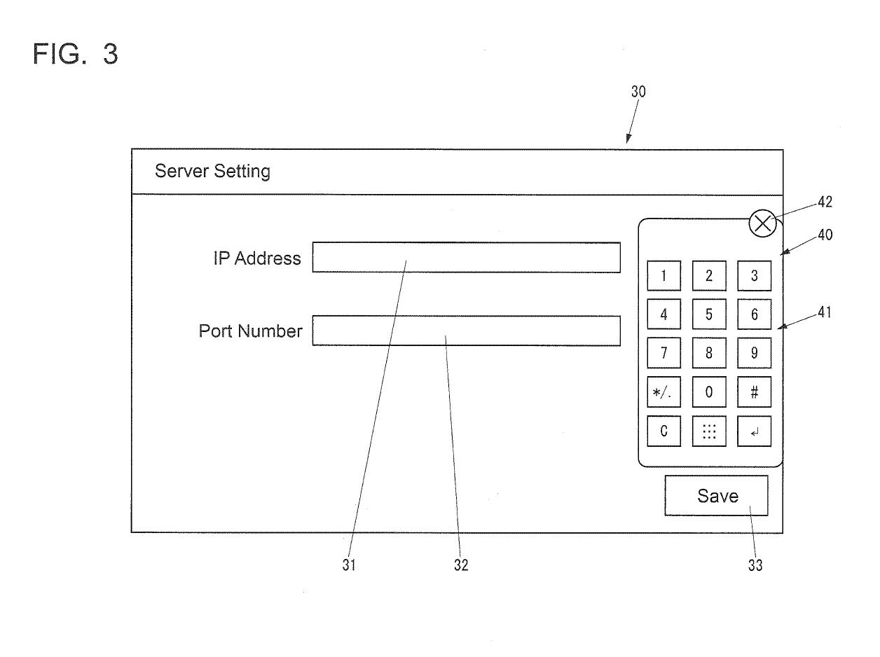

FIG. 3 illustrates an exemplary screen displayed on the touch panel 11 in a case of the “Floating layout.”

The screen illustrated in FIG. 3 includes a server setting screen 30 to set a server program as a communication partner of the MFP 10. The server setting screen 30 includes a text box 31, a text box 32, and a button 33. The text box 31 accepts an input of an Internet Protocol (IP) address to specify the server computer as the communication partner of the MFP 10. The text box 32 accepts an input of a port number to specify the server program as the communication partner of the MFP 10 among the programs on the server computer specified by the IP address specified in the text box 31. The button 33 is a button to store the values specified in the text boxes 31 and 32. The screen illustrated in FIG. 3 also includes a soft numeric keypad 40. The soft numeric keypad 40 includes a button 42 to terminate displaying in addition to various kinds of keys 41. While the soft numeric keypad 40 illustrated in FIG. 3 is located on the right edge side on the touch panel 11 in a state illustrated in FIG. 3, the soft numeric keypad 40 can be located on any position of the touch panel 11.

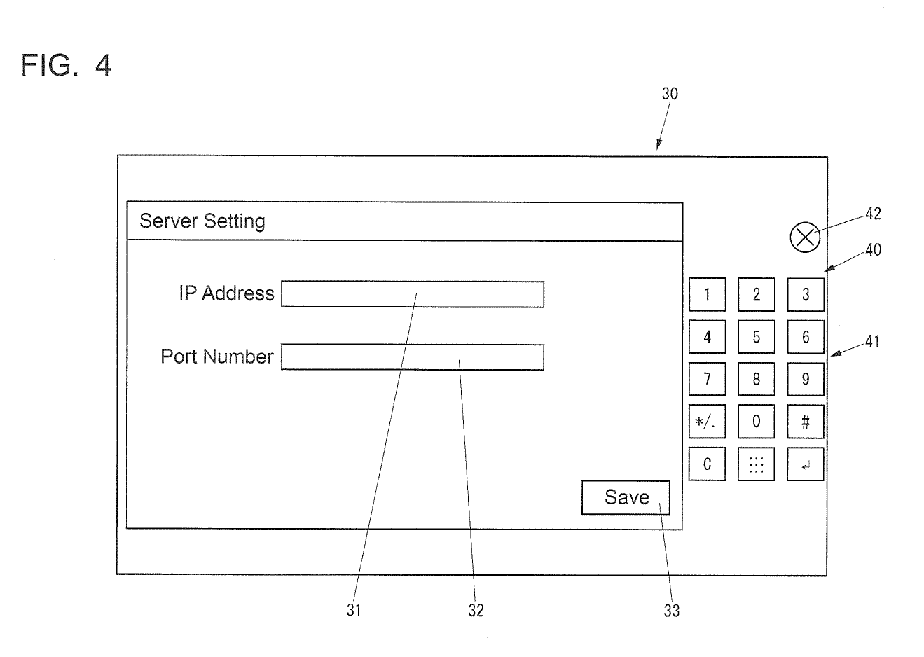

FIG. 4 illustrates an exemplary screen displayed on the touch panel 11 in a case of the “Right side layout.” As well as the screen illustrated in FIG. 3, the screen illustrated in FIG. 4 includes the server setting screen 30. As well as the screen illustrated in FIG. 3, the screen illustrated in FIG. 4 includes the soft numeric keypad 40. The soft numeric keypad 40 illustrated in FIG. 4 is located on the right edge side of the touch panel 11.

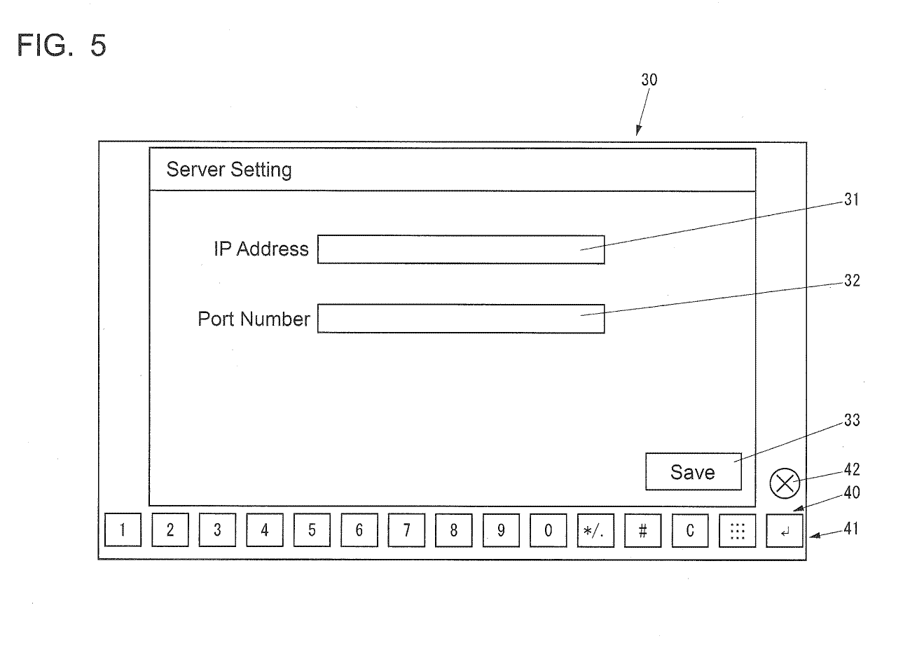

FIG. 5 illustrates an exemplary screen displayed on the touch panel 11 in a case of the “Horizontal layout.” As well as the screen illustrated in FIG. 3 or FIG. 4, the screen illustrated in FIG. 5 includes the server setting screen 30. As well as the screen illustrated in FIG. 3 or FIG. 4, the screen illustrated in FIG. 5 includes the soft numeric keypad 40. The soft numeric keypad 40 illustrated in FIG. 5 is located on the lower end side of the touch panel 11 in a state of horizontally long.

As illustrated in FIG. 2, the “display position setting” is configured to be set any of the set values of an “initial position (right side),” a “final display position,” and a “specified position.” The “initial position (right side)” indicates that an initial display position of the soft numeric keypad 40 on the touch panel 11 is the right edge side. The “final display position” indicates that the initial display position of the soft numeric keypad 40 on the touch panel 11 is a final display position of the previous operation. The “specified position” indicates that the initial display position of the soft numeric keypad 40 on the touch panel 11 is a position specified in advance. The “specified position” includes a specific position, for example, specified by a coordinate on the touch panel 11. The “display position setting” is configured to be set the set values corresponding to an instruction via, for example, the touch panel 11 or the communication unit 15.

The “arrangement type setting” and the “display position setting” indicate the arrangement of the soft numeric keypad 40 on the touch panel 11 and configure the arrangement setting of the disclosure.

The “hardware key setting” is configured to be set any of the set values of “On” and “Off.” The “On” indicates that the numeric keypad 19 is installed on the interface 16. The “Off” indicates that the numeric keypad 19 is not installed on the interface 16. The “hardware key setting” is automatically set by the control unit 18 corresponding to the installation state of the numeric keypad 19 on the interface 16.

The control unit 18 illustrated in FIG. 1 includes, for example, a Central Processing Unit (CPU), a Read Only Memory (ROM), which preliminarily stores programs and various data, and a Random Access Memory (RAM), which is used as a work area of the CPU. The CPU executes the programs stored in the ROM or the storage unit 17.

The control unit 18 executes the programs stored in the ROM or the storage unit 17 to function as a panel control unit 18a that executes the control of the display on the touch panel 11.

The control unit 18 executes the Java application 17b stored in the storage unit 17 to function as a setting acquiring unit 18b (also referred to as a setting acquiring circuit) and a software key display 18c (also referred to as a software key display circuit). The setting acquiring unit 18b acquires the software key setting 17c. The software key display 18c displays the soft numeric keypad 40 on the touch panel 11 corresponding to the software key setting 17c acquired by the setting acquiring unit 18b.

Next, a description will be given of the performance of the MFP 10.

First, a description will be given of the performance of the MFP 10 when the soft numeric keypad 40 is displayed.

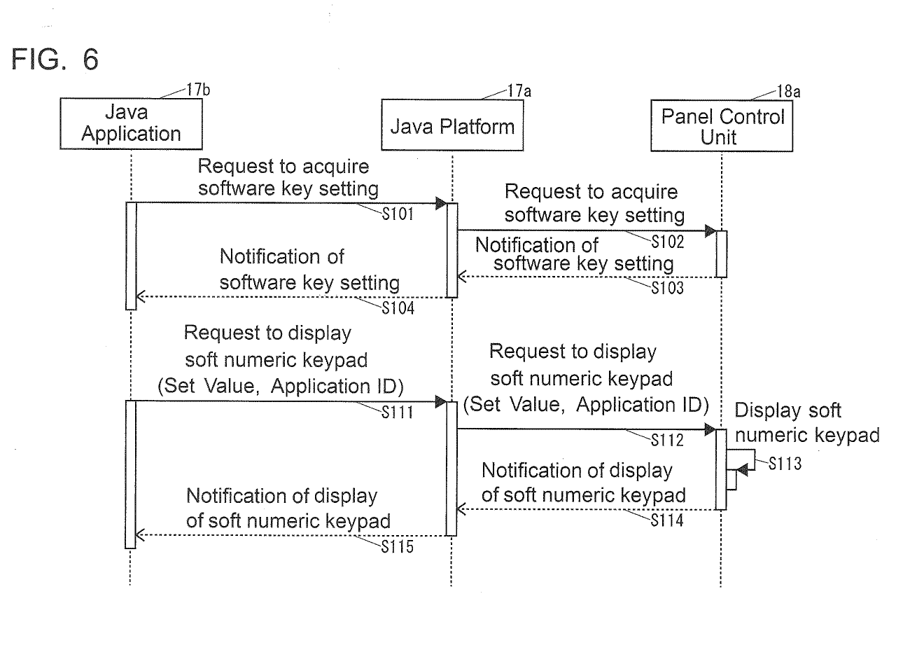

FIG. 6 illustrates a performance of the MFP 10 in a case where the soft numeric keypad 40 is displayed.

When a user instructs the activation of the Java application 17b via the touch panel 11, the control unit 18 activates the Java application 17b to start the performance illustrated in FIG. 6.

After the Java application 17b is activated, the Java application 17b displays a specific screen such as the server setting screen 30 illustrated in FIG. 3 to FIG. 5 for the Java application 17b itself on the touch panel 11. Then, the setting acquiring unit 18b of the Java application 17b requests the Java Platform 17a to acquire the software key setting 17c as illustrated in FIG. 6 (Step S101).

When the Java Platform 17a receives the request to acquire the software key setting 17c from the setting acquiring unit 18b in Step S101, the Java Platform 17a requests the panel control unit 18a to acquire the software key setting 17c (Step S102).

When the panel control unit 18a receives the request to acquire the software key setting 17c from the Java Platform 17a in Step S102, the panel control unit 18a acquires the software key setting 17c from the storage unit 17. Then, the panel control unit 18a notifies the Java Platform 17a of the software key setting 17c acquired from the storage unit 17 (Step S103).

When the Java Platform 17a receives the notification of the software key setting 17c from the panel control unit 18a in Step S103, the Java Platform 17a notifies the setting acquiring unit 18b of the Java application 17b of the notified software key setting 17c (Step S104).

When the set values of the “initial display setting” and the “hardware key setting,” which are the items of the software key setting 17c notified from the Java Platform 17a to the setting acquiring unit 18b in Step S104, are “On” and “Off” respectively, the software key display 18c of the Java application 17b requests the Java Platform 17a to display the soft numeric keypad 40 on the touch panel 11 (Step S111). Here, the software key display 18c includes the set values of the “arrangement type setting” and the “display position setting,” which are the items of the software key setting 17c notified from the Java Platform 17a to the setting acquiring unit 18b in Step S104, and an application ID as identification information of the Java application 17b itself in the request in Step S111.

When the set value of the “initial display setting,” which is the item of the software key setting 17c notified from the Java Platform 17a to the setting acquiring unit 18b in Step S104, is “Off,” the software key display 18c does not immediately execute the process of Step S111. The software key display 18c executes the process of Step S111 at a specific timing. Here, the specific timing includes a timing when operations that specifies the text box such as the text boxes 31 and 32 on the server setting screen 30 illustrated in FIG. 3 to FIG. 5, that is, dedicated operations to display the soft numeric keypad 40 on the touch panel 11 are input to the touch panel 11, and a timing when the soft numeric keypad 40 is preferred to be displayed on the touch panel 11, for example, a timing when a specific screen including the text box is displayed on the touch panel 11. The software key display 18c may determine the timing when the soft numeric keypad 40 is preferred to be displayed on the touch panel 11 corresponding to the operation input to the touch panel 11.

When the set value of the “hardware key setting,” which is the item of the software key setting 17c notified from the Java Platform 17a to the setting acquiring unit 18b in Step S104, is “On,” the software key display 18c does not execute the process of Step S111.

When the Java Platform 17a receives the request to display the soft numeric keypad 40 on the touch panel 11 from the software key display 18c in Step S111, the Java Platform 17a requests the panel control unit 18a to display the soft numeric keypad 40 on the touch panel 11 (Step S112). Here, the Java Platform 17a includes the set values and the application ID that are notified from the software key display 18c in Step S111 in the request in Step S112.

When the panel control unit 18a receives the request to display the soft numeric keypad 40 on the touch panel 11 from the Java Platform 17a in Step S112, the panel control unit 18a displays the soft numeric keypad 40 on the touch panel 11 corresponding to the set values notified from the Java Platform 17a in Step S112 (Step S113). Then, the panel control unit 18a notifies the Java Platform 17a of the display of the soft numeric keypad 40 on the touch panel 11 (Step S114).

When the Java Platform 17a receives the notification of the display of the soft numeric keypad 40 on the touch panel 11 from the panel control unit 18a in Step S114, the Java Platform 17a notifies the software key display 18c of the Java application 17b of the display of the soft numeric keypad 40 on the touch panel 11 (Step S115).

Next, a description will be given of a performance of the MFP 10 when the MFP 10 executes a performance corresponding to an operation to the soft numeric keypad 40 displayed on the touch panel 11.

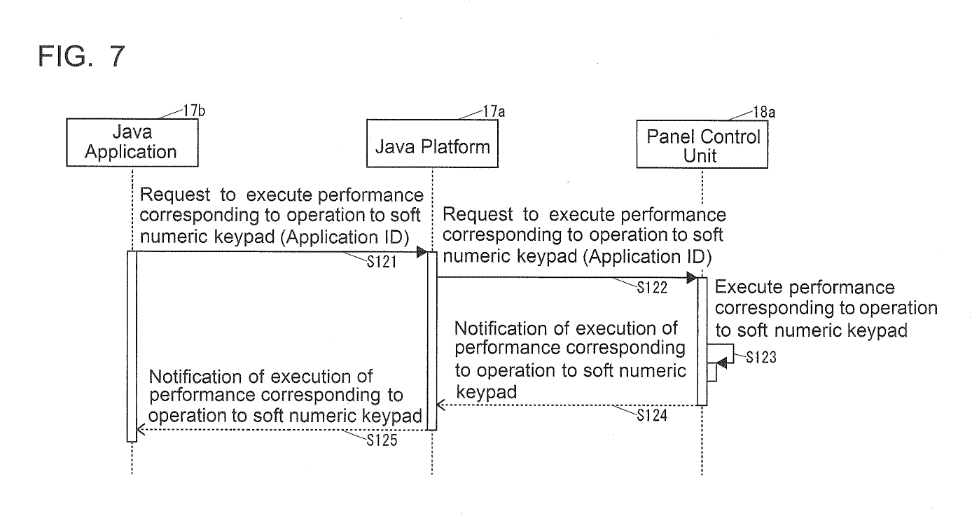

FIG. 7 illustrates a performance of the MFP 10 in a case where the MFP 10 executes a performance corresponding to an operation to the soft numeric keypad displayed 40 on the touch panel 11.

When an operation to the soft numeric keypad displayed 40 on the touch panel 11 is input on the touch panel 11, as illustrated in FIG. 7, the software key display 18c of the Java application 17b requests the Java Platform 17a to execute the performance corresponding to the operation to the soft numeric keypad 40 (Step S121). Here, the software key display 18c includes an application ID of the Java application 17b itself in the request in Step S121.

The performance corresponding to the operation to the soft numeric keypad 40 includes a performance that accepts the input corresponding to the operated key 41 by the operation to the various keys 41 of the soft numeric keypad 40, a performance that terminates the display of the soft numeric keypad 40 by the operation to the button 42 of the soft numeric keypad 40, and a performance that moves the position of the soft numeric keypad 40 on the touch panel 11 corresponding to the operation to the soft numeric keypad 40. Relating to the performance to move the position of the soft numeric keypad 40 on the touch panel 11, the software key display 18c executes the process of Step S121 only when the set value of the “arrangement type setting” as the item of the software key setting 17c is the “Floating layout.”

When the Java Platform 17a receives the request to execute the performance corresponding to the operation to the soft numeric keypad 40 from the software key display 18c in Step S121, the Java Platform 17a requests the panel control unit 18a to execute the performance corresponding to the operation to the soft numeric keypad 40 (Step S122). Here, the Java Platform 17a includes the application ID notified from the software key display 18c in Step S121 in the request in Step S122.

When the panel control unit 18a receives the request to execute the performance corresponding to the operation to the soft numeric keypad 40 from the Java Platform 17a in Step S122, the panel control unit 18a executes the performance required from the Java Platform 17a in Step S122 to the soft numeric keypad 40 that is associated with the application ID notified from the Java Platform 17a in Step S122 (Step S123). Here, the panel control unit 18a executes the process in Step S123 only to the soft numeric keypad 40 specified by the application ID. Accordingly, the panel control unit 18a can prevent the soft numeric keypad 40 associated with the application ID from performed by the software key display 18c of the Java application 17b other than the Java application 17b specified by the application ID that is included in the request to execute the performance corresponding to the operation to the soft numeric keypad 40.

When the panel control unit 18a terminates the display of the soft numeric keypad 40, the panel control unit 18a stores the final display position of the soft numeric keypad 40.

After the process of Step S123, the panel control unit 18a notifies the Java Platform 17a of the execution of the performance corresponding to the operation to the soft numeric keypad 40 (Step S124).

When the Java Platform 17a receives the notification of the execution of the performance corresponding to the operation to the soft numeric keypad 40 from the panel control unit 18a in Step S124, the Java Platform 17a notifies the software key display 18c of the Java application 17b of the execution of the performance corresponding to the operation to the soft numeric keypad 40 (Step S125).

As described above, the MFP 10 displays the soft numeric keypad 40 on the touch panel 11 at the timing corresponding to the set value of the “initial display setting” as the item of the software key setting 17c (Step S113). This eliminates the necessity of a dedicated operation for only displaying the soft numeric keypad 40 on the touch panel 11 to improve the operability of the soft numeric keypad 40.

When the set value of the “initial display setting” as the item of the software key setting 17c is “On,” the MFP 10 displays the soft numeric keypad 40 on the touch panel 11 at the timing of the activation of the Java application 17b. This eliminates the necessity of a dedicated operation for only displaying the soft numeric keypad 40 on the touch panel 11 to improve the operability of the soft numeric keypad 40.

When the set value of the “initial display setting” as the item of the software key setting 17c is “Off,” the MFP 10 displays the soft numeric keypad 40 on the touch panel 11 at the specific timing other than the timing of the activation of the Java application 17b. This eliminates the necessity of a dedicated operation for only displaying the soft numeric keypad 40 on the touch panel 11 to improve the operability of the soft numeric keypad 40.

The MFP 10 displays the soft numeric keypad 40 on the touch panel 11 in the arrangement corresponding to the set values of the “arrangement type setting” and the “display position setting” as the item of the software key setting 17c. This ensures to improve the operability of the soft numeric keypad 40.

The MFP 10 does not display the soft numeric keypad 40 on the touch panel 11 when the numeric keypad 19 as the hardware keyboard is installed on the interface 16, and displays the soft numeric keypad 40 on the touch panel 11 only when the set value of the “hardware key setting” as the item of the software key setting 17c indicates the numeric keypad 19 not to be installed. This ensures to improve the operability.

While the MFP 10 employs the numeric keypad as a keyboard according to the disclosure in the embodiment, a keyboard other than the numeric keypad may be employed.

While the electronic device of the disclosure is the MFP in the embodiment, it may be an image forming apparatus other than the MFP, such as a printer-only machine, a scanner-only machine, a copy-only machine, and a FAX-only machine, and may be an electronic device other than the image forming apparatus, such as a Personal Computer (PC).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An electronic device comprising:
a touch panel; and
a control unit that executes an application program,
wherein the control unit executes the application program to be functioned as:
a setting acquiring circuit that acquires a software key setting as a setting of an on-screen keyboard displayed on the touch panel; and
a software key display circuit that displays the on-screen keyboard on the touch panel corresponding to the software key setting acquired by the setting acquiring circuit,
wherein the software key setting includes a timing setting that indicates a timing when the on-screen keyboard is displayed on the touch panel.

2. The electronic device according to claim 1,
wherein the timing setting indicates that the on-screen keyboard is displayed on the touch panel at a timing of an activation of the application program.

3. The electronic device according to claim 1,
wherein the timing setting indicates that the on-screen keyboard is displayed on the touch panel at a specific timing other than the timing of the activation of the application program, and
the specific timing includes a timing other than a timing when a dedicated operation for displaying the on-screen keyboard on the touch panel is input on the touch panel.

4. The electronic device according to claim 1,
wherein the software key setting includes an arrangement setting that indicates an arrangement of the on-screen keyboard on the touch panel.

5. The electronic device according to claim 1,
wherein a hardware keyboard is installable,
the software key setting includes a hardware key setting that indicates an installation state of the hardware keyboard, and
the software key display circuit displays the on-screen keyboard on the touch panel only when the hardware key setting indicates that the hardware keyboard is not installed.

6. A non-transitory computer-readable recording medium storing an application program that causes an electronic device with a touch panel to function as:
a setting acquiring circuit that acquires a software key setting as a setting of an on-screen keyboard displayed on the touch panel; and
a software key display circuit that displays the on-screen keyboard on the touch panel corresponding to the software key setting acquired by the setting acquiring circuit,
wherein the software key setting includes a timing setting that indicates a timing when the on-screen keyboard is displayed on the touch panel.

7. A method for controlling an electronic device that includes a touch panel, comprising:
acquiring a software key setting as a setting of an on-screen keyboard displayed on the touch panel; and
displaying the on-screen keyboard on the touch panel corresponding to the software key setting acquired by the acquiring,
wherein the software key setting includes a timing setting that indicates a timing when the on-screen keyboard is displayed on the touch panel.
